(19) United States
(12) Patent Application Publication
(10) Pub. No.: US 2014/0046954 A1
(43) Pub. Date: Feb. 13, 2014

(54) SOFTWARE TOOL FOR CREATION AND MANAGEMENT OF DOCUMENT REFERENCE TEMPLATES

(71) Applicants: James E. MacLean, Ottawa (CA); Yiwu Lei, Ottawa (CA); Tony T. Lane, Ottawa (CA)

(72) Inventors: James E. MacLean, Ottawa (CA); Yiwu Lei, Ottawa (CA); Tony T. Lane, Ottawa (CA)

(73) Assignee: 3M Innovative Properties Company and a completed

(21) Appl. No.: 13/568,998

(22) Filed: Aug. 7, 2012

(51) Int. Cl. G06F 17/30

(52) U.S. Cl. 707/748; 707/736; 707/E17.009

(57) ABSTRACT

A software tool is described in which a document authentication software engine is tightly integrated with software for creating and managing reference templates for identifying different types of security documents, such as passports and driver's licenses. This integration allows an operator to test each individual change as a document reference template is being created to shorten the creation time and improve the accuracy of the template.

### TECHNICAL FIELD

The invention relates to computer-aided identification and validation of security documents, such as passports, driver's licenses, birth certificates, or financial documents, using a flexible document verification framework.

### BACKGROUND

Computer-aided techniques are increasingly being used to capture, identify, validate, and extract information from security documents. For example, security document readers, such as ePassport readers, are more commonly being deployed to read and confirm the authenticity of security documents. Examples of security documents include passports, credit cards, ID cards, driver's licenses, birth certificates, commercial papers, and financial documents. In order to authenticate different security documents, the security document reader may employ a wide variety of authentication tests, including those analyzing document sizes, static image patterns, and/or information collected from specific positions on the document and/or storage mediums, e.g., bar codes, machine-readable zones, and RFID chips. The document is determined to be authentic depending on how well the document passes the authentication tests.

Modern security document readers and authentication systems support a variety of different types of security documents, such as passports issued by various states or countries. In order to confirm that a security document is authentic, an authentication system needs to first identify the security document in order to determine which set of authentication tests to use as the basis for the authentication. For example, authentication of a British passport may require application of different algorithms and/or analysis of different portions of the passport than, for example, authentication of an Australian passport. Identification of the document typically involves performing a set of identification tests to measure the characteristics of the document and comparing the measurements to expected results.

To facilitate identification and authentication of a variety of security documents, modern authentication systems utilize reference templates, also referred to as document reference templates, for the security documents. Each reference template specifies the identification tests to be used to identify the corresponding type of security document and the authentication tests to confirm that the document in question is authentic.

Creating and managing the document reference templates for use by the security document readers and authentication systems is a complex task. For example, creating and/or modifying a reference template for a specific type of security document typically involves making a change using a template editing tool, deploying the modified template to the document reader/authentication system, restarting the authentication system to load the new and/or modified templates, and running a test application to view the results. If the results are not correct, the user must typically restart at the beginning by restarting the template editing tool and modifying and/or creating an authentication template. The current trial and error approach takes a long time and is often difficult to come up with a good template. Moreover, changes to one reference template may inadvertently affect the results of other reference templates in that those templates may no longer be considered best matches for their corresponding security documents. As a result, creation and management of security document reference templates can be a long and tedious task.

### SUMMARY

In general, a software tool is described in which a document authentication software engine is tightly integrated with software for creating and managing reference templates for identifying different types of security documents, such as passports and driver's licenses. This integration allows the operator to test each individual change as a document reference template is being created to shorten the creation time and improve the accuracy of the template.

In one example, a computer-implemented system includes a host computer having a hardware-based processor and a software tool executing on the processor. The software tool provides a database storing a hierarchically arranged set of reference templates, each reference template defining a set of verifiers specifying instructions for identifying and authenticating a corresponding type of security document based on one or more attributes of the type of security document. The software tool further includes a document processing engine that controls a document reader to acquire data from an unknown type of security document. In response to the data acquired by the document reader, the document processing engine applies the reference templates to the data to compute a score value for each reference template and identify the unknown security document as one of the types of security documents. A template analysis component of the software tool presents an interface by which a user may create and edit the reference templates within the database. The document processing engine and the template analysis component are integrated within the software tool and communicate by an application programming interface (API) within the software tool. For example, the template analysis component may invoke the document processing engine by the API while a user is editing one of the reference templates to test changes to the reference template with respect to the data acquired from the unknown type of security document without requiring that the user exit the template analysis component or restarting the document processing engine.

In another embodiment, a method comprises receiving, with a template analysis component of a software tool executing on a computer, input from a user creating a new reference template within a hierarchy of reference templates stored in a database, wherein the input defines a verifier for the new reference template specifying instructions for identifying a corresponding type of security document based on one or more attributes of the type of security document. The method further comprises invoking, with the template analysis component, a document processing engine integrated within the software tool to apply the verifier of the new reference template to data acquired from an unknown type of security document without requiring that the user exit the template analysis component or restarting the document processing engine; and presenting results of application of the verifier through a user interface of the software tool.

In another embodiment, the invention is directed to a computer-readable medium containing instructions to execute the methods described herein.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a schematic representation illustrating an exemplary system for creating and managing document reference templates in accordance with the techniques described herein.

FIG. 2 is a block diagram providing a high-level overview for application and use of a host system.

FIG. 3 is a block diagram illustrating in more detail one example of a host system that provides an operating environment for software tool that integrates a template analysis component for template creation and management and a document processing engine for document identification and authentication.

FIGS. 4-18 are screen shots presented by a graphical user interface of the software tool described herein.

### DETAILED DESCRIPTION

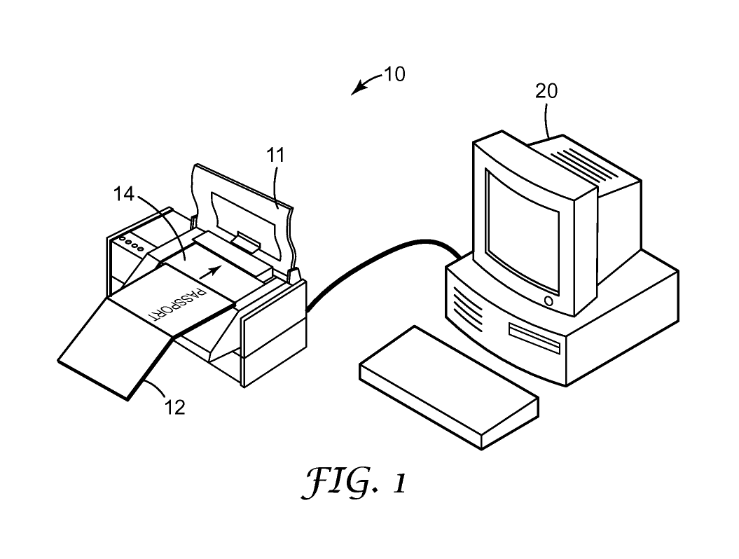

FIG. 1 is a schematic representation illustrating an exemplary system 10 for creating and managing document reference templates in accordance with the techniques described herein. In the example of FIG. 1, system 10 includes a host computer system 20 coupled to a document reader 11, such as an ePassport document reader. As described herein, host computer 20 provides an operating environment for a software tool in which a document authentication software development kit (SDK) is tightly integrated with template creation and management functions. That is, the software tool provides dual functionality. A first component of the tool, referred to herein as a template analysis component, includes software modules that allow a user to create and manage the document reference templates that are applied by the document authentication SDK. The template analysis component provides a framework for specifying and editing the distinct set of authentication tests to be applied for each template when identifying and authenticating different types of security documents. A document processing engine of the software tool provides functionality that allows any newly modified reference template to be immediately and seamlessly applied by document reader 11 to test the modified reference template, as well as the complete hierarchy of reference templates, against a sample security document 12. For example, the user may test the modified reference template without leaving the environment provided by the software tool and without restarting any authentication engine normally required by document reader 11. Moreover, as described herein, the software tool may allow the user to immediately apply and confirm an individual test defined within a reference template, an entire reference template, or an entire hierarchy of templates so as to determine whether the authentication engine correctly applies the hierarchy to identify the different types of security documents supported by the hierarchy.

Document reader 11 works as an image capture device for confirming that security document 12 is a valid, authentic security document. As described herein, document reader 11 supports a wide-variety of types of security documents. As part of the authentication process, document reader 11 first identifies the particular type of security document inserted into the device. For example, security document 12 may be a United States passport, a United States state-specific driver's license, a United States state-specific identification card, a European Union (E.U.) driver's license, a E.U. identification card, passports or identification documents issued by various state or country governmental agencies throughout the world, title documents, identification cards, and a variety of other document types. After identifying the type of security document, system 10 may proceed to validate and extract information from security document 12.

For example, host computer system 20 of system 10 may be used to direct document reader 11 to initially capture a sequence of one or more images of all or a portion of security document 12. In operation, the user places security document 12 onto view frame 14 of the document reader 11. View frame 14 accurately locates security document 12 with respect to other components of document reader 11. After the user has placed security document 12 onto view frame 14, document reader 11 captures a sequence of one or more images of security document 12. The captured images may represent all or a portion of security document 12, but typically the captured images represent all of security document 12. Document reader 11 communicates the captured image data to host system 20 for image processing.

Next, a two-stage process is employed by which the software tool executing on host system 10 first invokes the integrated document processing engine to identify the type of security document and then confirms that security document 12 is a valid document of the identified type based on analysis of the captured image data, possibly in conjunction with other data obtained from the security document. For example, in addition to the scanned image data captured from security document 12, system 10 may utilize data received from one or more machine-readable zones (e.g., barcodes), data received from radio frequency identification (RFID) chips embedded within or affixed to the document, or other sources of information provided by the document.

In one example, the document processing engine utilizes a dynamic document identification framework that can easily be extended and modified so as to support reference templates for a wide variety of different types of security documents. The document processing engine interacts with the framework as necessary to invoke various algorithms to categorize and ultimately identify security document 12 as a particular type of document, e.g., a security document issued by a specific agency and having certain characteristics and layout features required for subsequent authentication. System 10 may store the document identification framework as a hierarchically arranged, tree-like data structure within a memory, database, or other storage media (not shown in FIG. 1). Data structures referred to herein as document object types are used to represent each node within the tree-like data structure. Parent nodes represent categories or sub-categories of document types and can be recursively traversed down into the multiple levels of the hierarchy. The leaf nodes represent specific document types, e.g., a United States passport document type object, a United States driver's license document type object, or a United States identification card document type object. Some of the document type objects within the framework may include one or more stored images or templates as well as a set of specified characteristics that clearly delineate one document type object from another. For example, a United States passport document type object may comprise an image of a template of a United States passport as well as a set of characteristics defining the occurrence of a machine-readable zone at the bottom of the United States passport template image, measurements delineating the placement of a picture within the template, and other data directed at determining the relative positions between various characteristics. Further example details of such a framework are described in U.S. patent application Ser. No. 11/955,163, entitled “IDENTIFICATION AND VERIFICATION OF AN UNKNOWN DOCUMENT ACCORDING TO AN EIGEN IMAGE PROCESS,” hereby incorporated herein by reference.

After successfully identifying that security document 12 conforms to one of the plurality of stored document type objects, the document processing engine of the software tool performs the authentication process to confirm the authenticity of the security document. For example, system 10 may analyze the captured image(s) to determine whether one or more occurrences of a stored reference image are present within the security document. If the reference image is present within the security document, system 10 may provide an indication (e.g., audible and or visual) that security document 12 has been properly authenticated. If the reference image is not present within the captured image, system 10 provides an indication that security document 12 cannot be automatically authenticated and may be denied.

The software tool described herein provides a number of features that allow the user to execute the identification, data capture and authentication processes of the document processing engine from within the template analysis component. These features may allow the user to better understand the impact of each individual change as changes are made to the reference templates and how each of the parameters and thresholds is applied when invoked by the authentication engine relative to a security document 12. These features may also shorten the development time by shorting the feedback loop for the user.

As one example, the tool allows incremental testing of a reference template to be conducted using a single sample security document 12 or a group of sample reference documents that are of the same type or of multiple types. When testing a group of sample security documents, the tool may generate statistical metrics for the group such as a highest score, a lowest score, mean, mode and average score. Group testing may assist the user in understanding how a change of a specific process will work across a range of sample documents.

As another example, the tool described herein supports a form of parameter learning with respect to parameters and thresholds to be specified when creating or modifying a reference template. In general, some users may not have a strong understanding of one or more image processing algorithms required for certain reference templates. To assist these users in selecting and setting the parameters to use for a process, the software tool described herein can be configured to operate in a learning mode in which the software tool calculates a recommended set of parameters and thresholds for a reference template based on data captured from one or more sample reference documents.

In one example, the tool further supports a form of template learning. When configured to operate in this mode, the software tool executes the document identification process across a set of templates for a new or unknown document to determine where to place a new template for the document within the hierarchy of reference templates, i.e., the classification framework. This may be useful in that identification results for a reference template for a particular type of document may be dependent upon where the reference template is placed within a given hierarchy of reference templates. Managing a large set of reference templates can be very challenging, and this feature may provide a user with a starting point within a hierarchy for inserting a reference template for a new type of document.

Another function that may be provided by the software tool is automatic authentication feature extraction. Depending on the type of document, there may be typical authentication features that are more appropriate than others. To aid definition of the correct authentication process, this mode of operation causes the software tool to analyze a document to identify any known feature types and automatically generate authentication processes that are added to the reference template being created.

The tool may support batch testing that provides the capability to test a large number of sample test documents against an individual reference template or a full set of reference templates. Individual test results are generated for each sample document. These results may include actual measured or computed values and pass/fail results for a given sample document for each reference template. The tool may compute and display statistical metrics of accuracy for each of the individual templates of the set of templates.

In another example, the tool includes revision control mechanisms for managing revisions of the individual templates for identified sets or subsets of templates. From within the tool, the user is able to check in and out reference templates from the template repository. In addition, the tool allows the user to view the revision log of a given reference template; and retrieve previous versions of the reference template. The revision management mechanisms assist in tracking template customization.

The tool described herein provides an environment for interactively and incrementally testing reference templates for identifying security documents. In one example, the tool provides execution tracing in which an execution trace is generated and recorded throughout the identification process. This may include, for example recording each step as the document processing engine traverses the hierarchy of reference templates and selects a new reference template to apply to the document being tested. The execution trace may include a history of each test applied for each reference template, including any resulting values and parameters and pass or failure result. The execution trace can be displayed in text format or in a graphical format that can be overlaid onto a graphical representation of the classification framework. For example, the trace information could be overlaid on to a graphical representation of the template hierarchy in a tree-like structure. This may allow the user to properly analyze the effectiveness of an overall solution of reference templates or to debug a specific issue associated with a reference template, which may be very useful given that identification and authentication processes tend to be very complex.

In certain examples, the template analysis component of the tool may allow the user to define multilevel thresholds for each reference template. This may be useful, for example, in that different organizations have varying levels of risk tolerance and that some identification and authentication processes are more time and resource intensive than others. For example, a risk adverse environment may want to include all possible checks to determine the overall pass/fail results. A low risk environment may be willing to reduce the number of checks in order to increase throughput. In order to support various implementations, each identification and authentication process within a reference template can be assigned a risk level and, if applicable, multiple threshold values. Each of the multiple thresholds has an assigned risk level. In operation, the document processing engine executes those processes that have a risk level equal to or less than the overall risk level required by the environment, as configured by the user. For processes that have multiple thresholds, the threshold that corresponds to the overall risk level required by the environment is used. In this way, multiple reference templates for the same security document need not be specified for operating environments having different risk tolerance levels.

To assist organizations in understanding the different risk levels, and the effects therefrom, the software tool allows the batch testing of a set of sample security documents 12 to be invoked and automatically executed across multiple risk levels. The tool computes and displays statistical results across each level for the set of sample security documents, such as number of passed, false positive, false negatives and timing. The result can be generated across all the templates or for specific subsets or individual document. The tool may also provide a comparison across the various overall risk levels as well as across different rounds of batch testing.

In this way, the software tool provides an environment in which template creation and management functions is tightly integrated with the document authentication software engine. These and other features provided by the software tool are illustrated in further detail below. Moreover, each of these features and functions may be utilized, either singularly or in any combination with other features or functions, in different example implementations of the software tool.

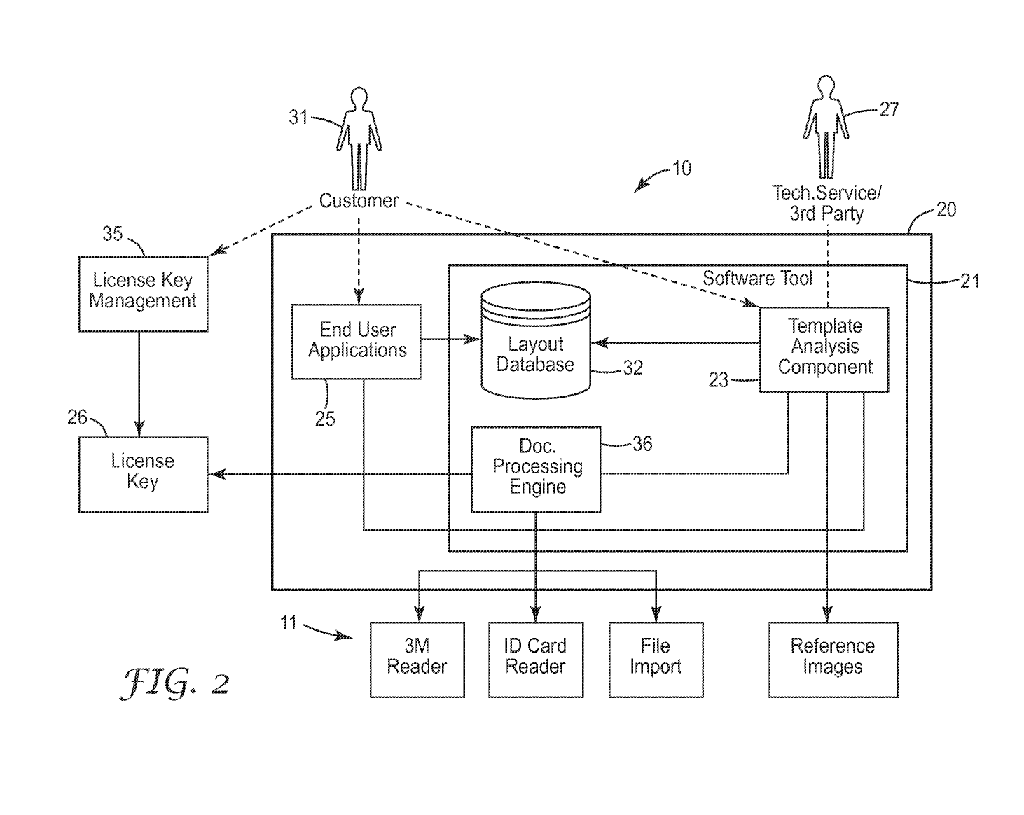

FIG. 2 is a block diagram providing a high-level overview for application and use of host system 20. In general, a technical service engineer 27 or other expert may interact with the software tool 21 executing on host system 20 and invoke the features provided by the tool to construct and incrementally test reference templates for storage within layout database 32. Using the features described herein, technical service engineer 27 may interact with template analysis component 23 to define a set of reference templates within database 32 and logically arrange the templates within a hierarchy of templates, i.e., a classification framework. During this process, technical service engineer 27 may seamlessly invoke the functions of document processing engine 36 to execute the identification, data capture and authentication processes of the document processing engine from within the template analysis component 23.

Once deployed, customer 31 may interact with end-user applications 25, which my in turn invoke the underlying document processing engine 36 to identify and authenticate security documents using document reader(s) 11. In addition, customer 31 may also invoke template analysis component 23 and utilize any of the features described herein of software tool 21 to customize and test one or more of the reference templates stored within layout database 32. During this process, document processing engine 36 may utilize one or more license keys 26 issued by key management system 35 to ensure that installed software components are licensed by a trusted source. Although described for exemplary purposes with respect to data received from a document reader 11, software tool 21 including, for example, document processing engine 36 and template analysis component 23 may utilize stored images and/or other data that was previous captured from, generated from or otherwise simulate corresponding security document(s).

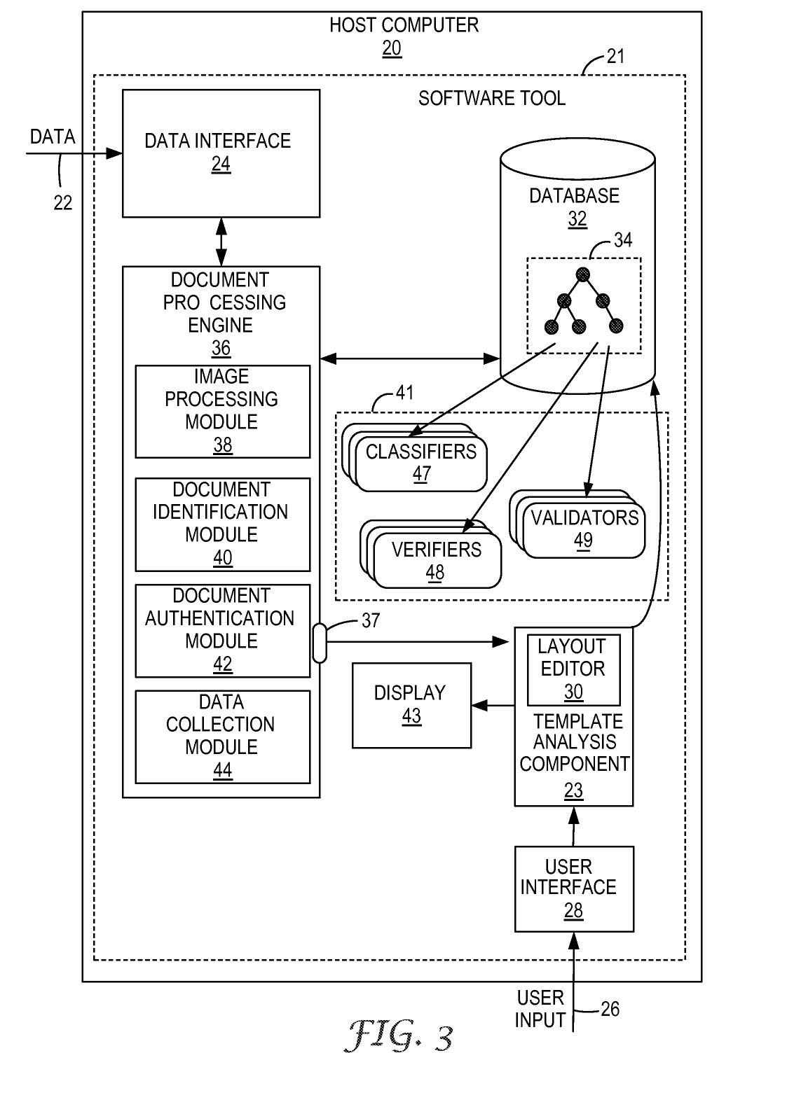

FIG. 3 is a block diagram illustrating in more detail one example of a host system 20 that provides an operating environment for software tool 21 that integrates a template analysis component 23 for template creation and management and a document processing engine 36 for document identification and authentication. Template analysis component 23 provides a number of features that seamlessly invoke the identification, data capture and authentication processes of the document processing engine 36 from within the template analysis component. These features may allow the user to understand the impact of each individual change as changes are made to the reference templates and how each of the parameters and thresholds is applied when invoked by document processing engine 36 relative to a security document.

As shown in FIG. 3, document processing engine 36 exposes API 37 internally within software tool 21 that allows template analysis component 23 to invoke the identification and authentication functions while a user creates and edits reference templates. For example, template analysis component 23 includes a layout editor 30 by which a user (not shown) edits reference templates stored within database 32. For example, the user may interact with a graphical user interface 28 presented by layout editor 30 to edit reference templates stored to database 32 to extend document identification framework 34 to support different document types. In some instances, a user may interact with layout editor 30 to manually specify a new document type object for insertion into document identification framework 34. At this time, the user may define the attributes that are characteristics of the category, sub-category or individual document type. In addition, the user may associate the document type object being inserted with one or more new or existing algorithms for storage as classifiers 47, verifiers 48 and validators 49. In other words, layout editor 30 may present a user interface 28 to receive user input 26 by which a user specifies commands to edit a reference template, such as commands that add or remove classifiers 47, verifiers 48 and validators 49 associated with a pre-defined reference template, to insert a new reference template either manually or automatically, to remove a reference template, to re-order the nodes of document identification framework to prioritize the application of classifiers 47, verifiers 48 validators 49 and other commands. As such, a user may engage layout editor 30 to tailor document identification framework 34 to more quickly identify security document types.

During this process, template analysis component 23 may invoke document processing engine 36 to execute the identification, data capture and authentication processes of the document processing engine from within the template analysis component. For example, template analysis component 23 may, in response to user input, output commands to document processing engine 36 via API 37 to trigger incremental testing of a newly created reference template against a sample security document 12 or a group of sample reference documents that are of the same type or of multiple types. At this time, for example, template analysis component 23 may communicate data via API 37 that identifies a specific reference template to be used. In this case, document processing engine 36 applies the particular reference template, e.g., the reference template recently created by layout editor 30, rather than traverse the hierarchy of reference templates defined by document identification framework 34. As another example, template analysis component 23 may direct document processing engine 36 via API 37 to enter a trace mode by which the processing engine creates a history of each test applied by the reference template, including any resulting values and pass or fail results. Document processing engine 36 may communicate the trace history to template analysis tool 23 via API for presentation to the user. As another example, document processing engine 36 provides results of the tests to template analysis component 23 via API 27 to allow template analysis component 23 to provide the user with immediate feedback. Layout analysis editor 23 supports batch testing that provides the capability to test a large number of sample test documents against a full set of reference templates. In this example, layout analysis editor 23 may iteratively invoke document processing engine 36 to test a reference template being created against each sample document in the batch. During this process, layout analysis editor 23 may accumulate and generate statistical data for the result data returned by document processing engine for each test.

When invoked through API 37, document processing engine 36 receives the captured data and performs an identification process and optionally a subsequent authentication process in accordance with the commands received from template analysis component 23. In the example embodiment of FIG. 3, document processing engine 36 includes an image processing module 38 and a document identification module 40 to perform the document identification process. For example, when template analysis tool 23 requests application of a specific reference template, document identification module 40 selects and applies one or more of the classifiers 47, verifiers 48 and validators 49 defined by the reference template. In contrast, template analysis tool 23 may direct document identification module 40 to perform a full identification process of a sample security document or set of documents. In response, document processing engine 36 traverses document identification framework 34 by selectively invoking a plurality of classifiers 47, verifiers 48 and validators 49 of the reference templates to categorize and ultimately identify the security document as one of the plurality of document types supported by document identification framework 34. During this process, document processing engine 36 accesses layout database 32 and utilizes the set of references templates arranged as document identification framework 34. Document processing engine 36 analyzes image data 22 and optionally other data (e.g., RFID data) received from document reader 11 (FIG. 1) to dynamically identify security document 12. In this example, host system 20 includes a data interface 24 to receive data (e.g., image and RFID data) from document reader 11. The image data received by data interface 24 may represent captured image(s) of all or a portion of security document 12. For example, the image data may contain one or more images, text, MRZ, barcode, watermarks, or other information. Data interface 24 may be, for example, a serial or parallel hardware interface for communicating with document reader 11. As another example, data interface 24 may be a universal serial bus (USB) interface. Although described for exemplary purposes with respect to data received from a document reader 11, software tool 21 including, for example, document processing engine 36 and template analysis component 23 may utilize stored images and/or other data that was previous captured from, generated from or otherwise simulate corresponding security document(s).

As shown in FIG. 3, document identification framework 34 may be represented as a tree-like structure having a plurality of nodes, where the nodes represent categories of security documents, sub-categories of security documents, or specific types of security documents. Document identification framework 34 is organized as a tree-like data structure for easy extensibility. Each of the nodes of document identification framework 34 may include one or more references to a set of document identification software modules 41 that includes classifiers 47, verifiers 48 and validators 49, each of which define instructions for checking for one or more attributes or characteristics of a security document.

Document authentication module 42 confirms the authenticity of the security document once identified. Data collection module 44 extracts relevant information from the article, e.g., security document 12. In particular data collection module 44 may engage document reader 11 to read bar codes, interrogate RFID chips, and read magnetic strips present on security document 12, thereby collecting additional data that may not be contained in the image data.

Upon receiving the captured image data, image processing module 38 may invoke image pre-processing algorithms to generate higher-quality gray, color or binarized images from the captured image data. Image processing module 38 may determine whether image processing is necessary based upon the type of light source used when capturing the image, e.g., a UV light source may require certain image processing algorithms, or based upon certain aspects of the captured image(s), e.g., a dark background with light text may require certain inversion image algorithms. Preprocessing may also be done based the type of document reader 11. For example, one type of document reader may have a different color profile than another type of document reader. The image preprocessing would ensure that the color is consistent across different reader models. Once the image data has been pre-processed, if necessary, document identification module 40 further analyzes the image data as well as other data obtained by data collection module 44 to identify the type of security document.

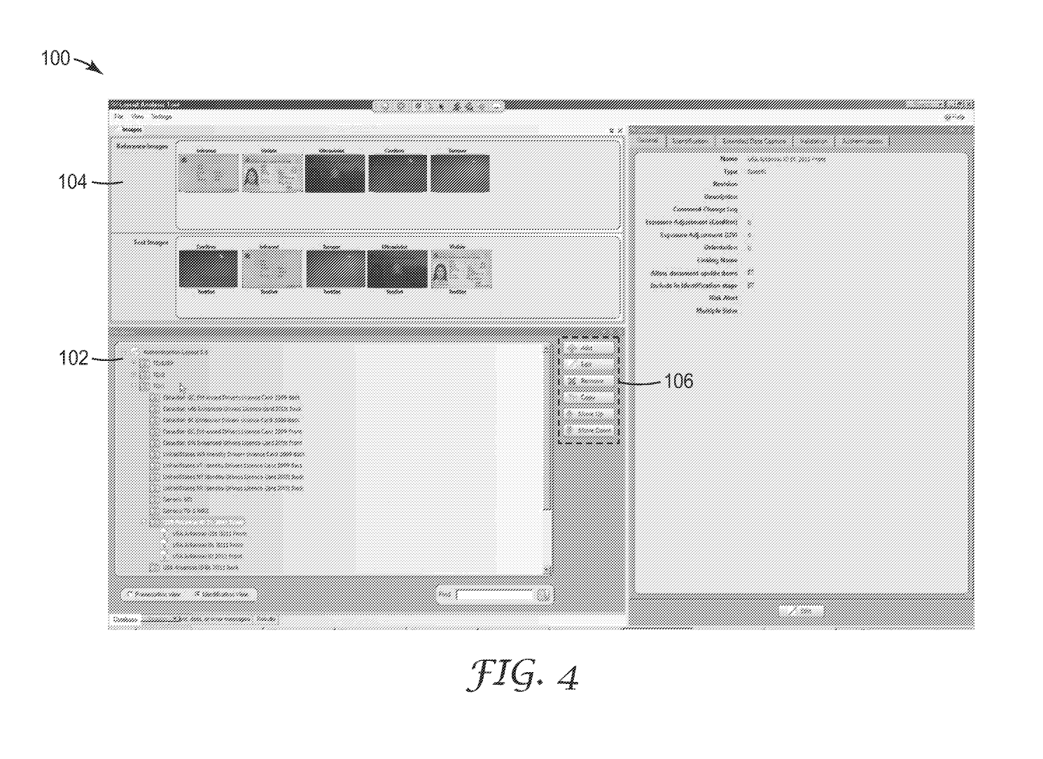

FIGS. 4-18 are screen shots of a window 100 presented by graphical user interface 28 layout editor 30 to a user via display 43. FIG. 4, for example, illustrates an example user interface window 100 having a sub-window 102 that provides a graphical tree-like representation of the hierarchical arrangement of the reference templates within database 32. In addition, window 100 includes sub-window 104 for showing reference images and test images to be utilized as inputs by document processing engine 36 when applying one or reference templates being edited or created. Sub-window 104 includes input mechanisms 106 that allow the user to insert, edit or delete a reference template within the graphical tree-like representation of the hierarchical arrangement of the reference templates. In addition, the user may manage the hierarchy of reference templates by moving reference templates up or down the hierarchy.

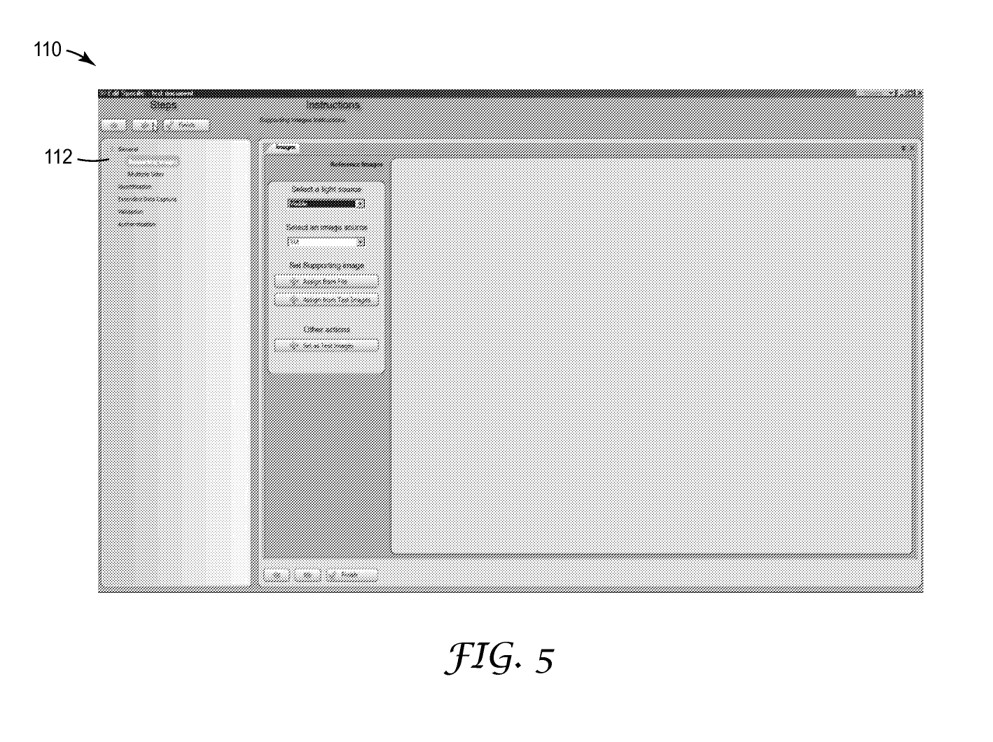

FIG. 5 illustrates window 110 with which the user interacts to create a new template. Sub-window 112 presents a wizard-type interface that allows the user to walk through the steps for defining a reference template, including (1) specifying images with which to work when defining the template, (2) defining the identification process for the reference template, (3) defining any extended data capture functions, such as RFID, (4) defining the validation process for the reference template, and (5) defining the authentication process. During these steps, the user is able to select currently-defined classifiers and verifiers or specify new ones.

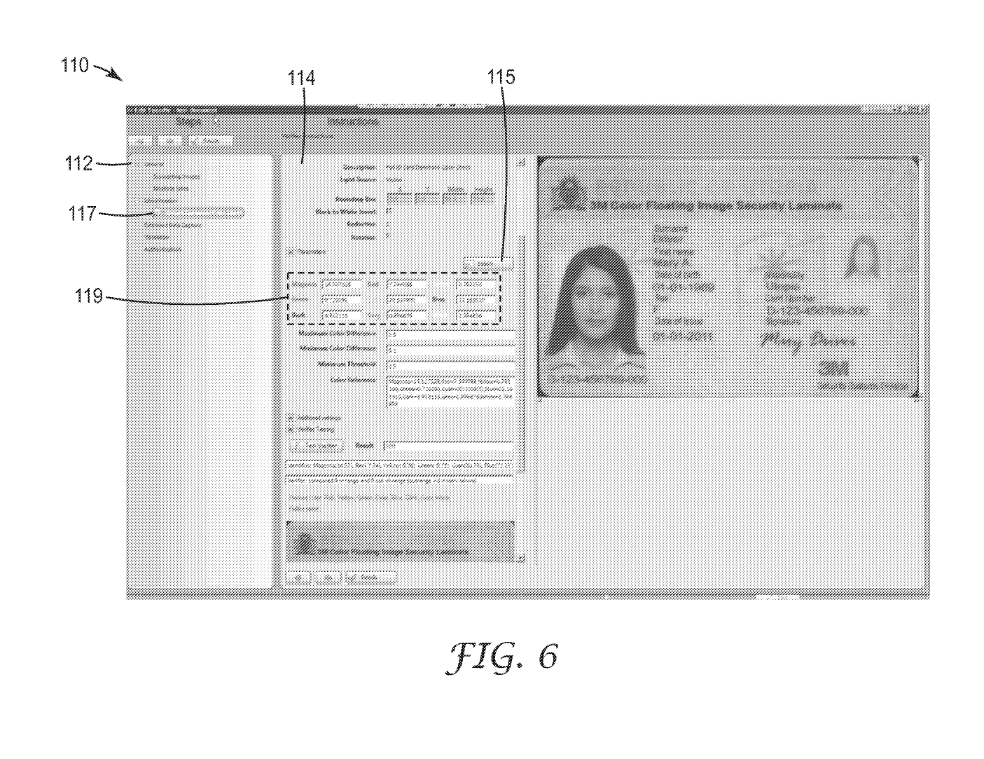

FIG. 6 illustrates window 110 and sub-window 112 when the user has elected to specify a first verifier 117 to be used by the newly created reference template when determining whether a security document is of the type corresponding to the reference template. As shown in FIG. 6, sub-window 114 allows the user to specify the specific configuration settings for each verifier for the identification phase of the reference template, including parameters, settings, confidence levels, and expected results. Further, sub-window 114 includes Learn button 115 that, when selected, causes template analysis component 23 to operate in a verifier learning mode. In this mode, template analysis component 23 invokes document processing engine 36 to process the sample security document and extract the parameters specified by the user, i.e., image parameters 119 in this example. In this example, template analysis component 23 has invoked document processing engine 36 to compute values for image parameters 119 required for performing a dominant color check. In this way, the user may direct template analysis component 23 to “learn” a set of initial values for the specific algorithms of the verifiers being defined by using a sample of the security document associated with the reference template being created. The user may modify the initial values as necessary to finalize the verifier.

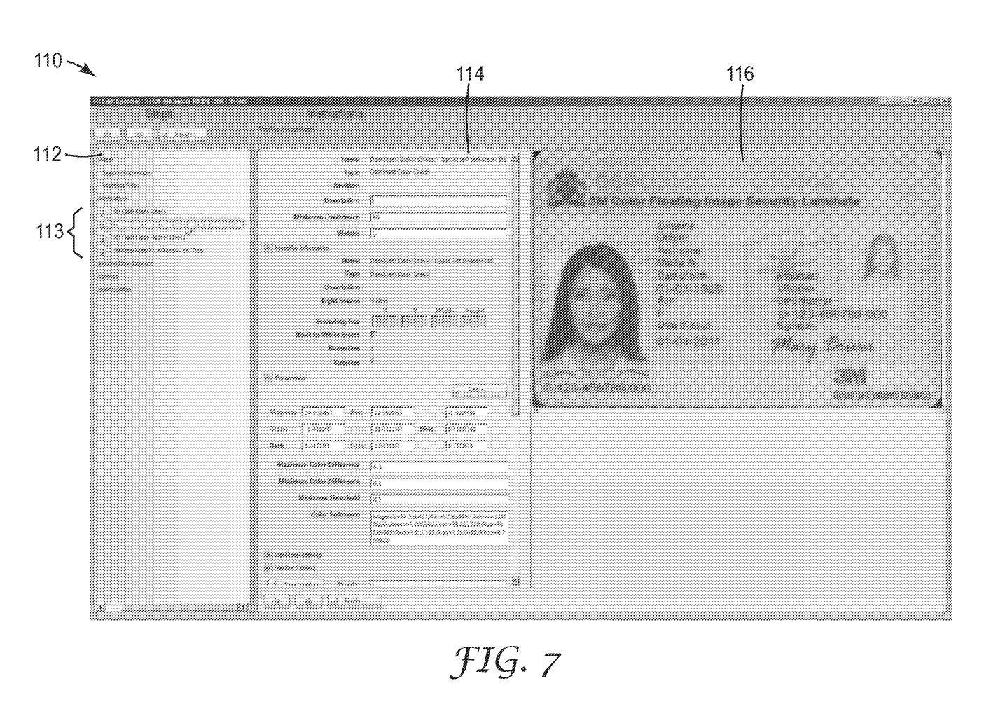

FIG. 7 illustrates an example window 110 having input mechanisms by which a user defines a series of verifier instructions for a particular new reference template. Window 110 includes a sub-window 112 that displays the series of verifier instructions 113 for identifying a type of security document. For each verifier instruction, sub-window 114 allows the user to specify the specific configuration settings for each test for the identification phase of the reference template, including parameters, settings, confidence levels, and expected results. In this example, sub-window 114 displays the specific configuration settings for a second verifier test (i.e., a dominant color check) to be applied in the identification sequence for the reference template. Sub-window 116 shows example image data captured from a sample document of the type of document for the reference template being edited.

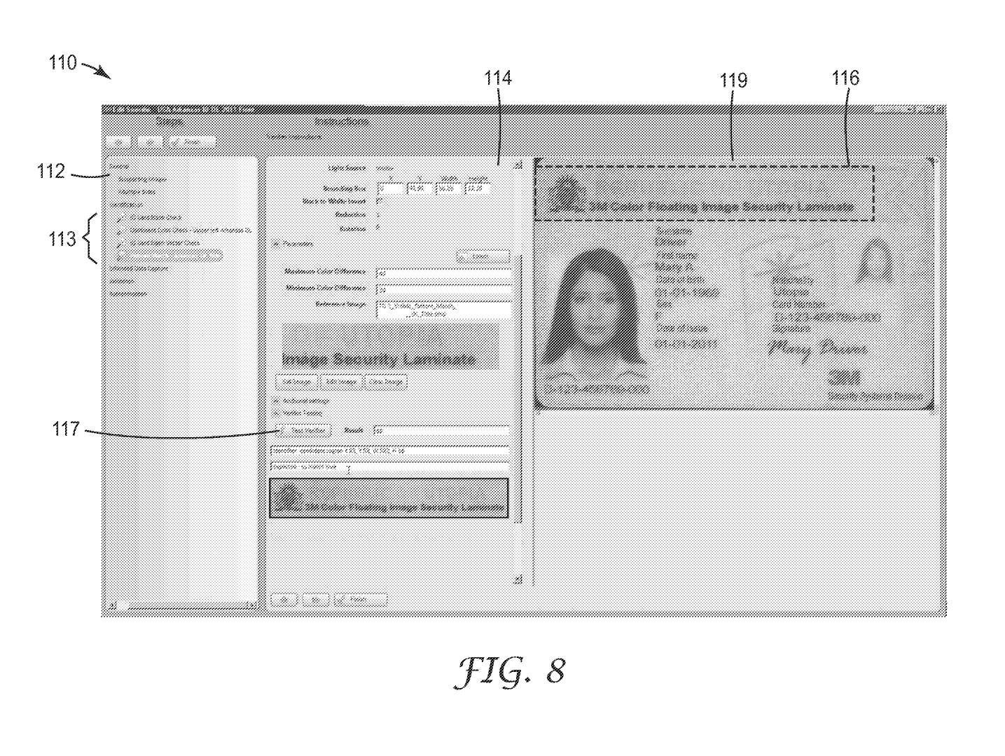

FIG. 8 illustrates window 110 and sub-window 114 for another verifier test (i.e., a pattern match verifier in this example) to be applied in the identification sequence for the reference template. As shown, sub-window 114 allows the user to specify a reference image to be used as a source for the image pattern and a bounding box 119 defining a region within the image of sub-window 116 to which the image pattern is to be applied. The Test Verifier button 117 causes the software to run the defined test on the image data that is defined within bounding box 119 and provided the results and shows a normalized result of the test. This provides real-time feedback for a particular verifier that may be one of a series of verifiers 113 defined for identifying a reference template. This allows the user to modify the parameters for the specific verifier and repeatedly apply the verifier against a sample security document.

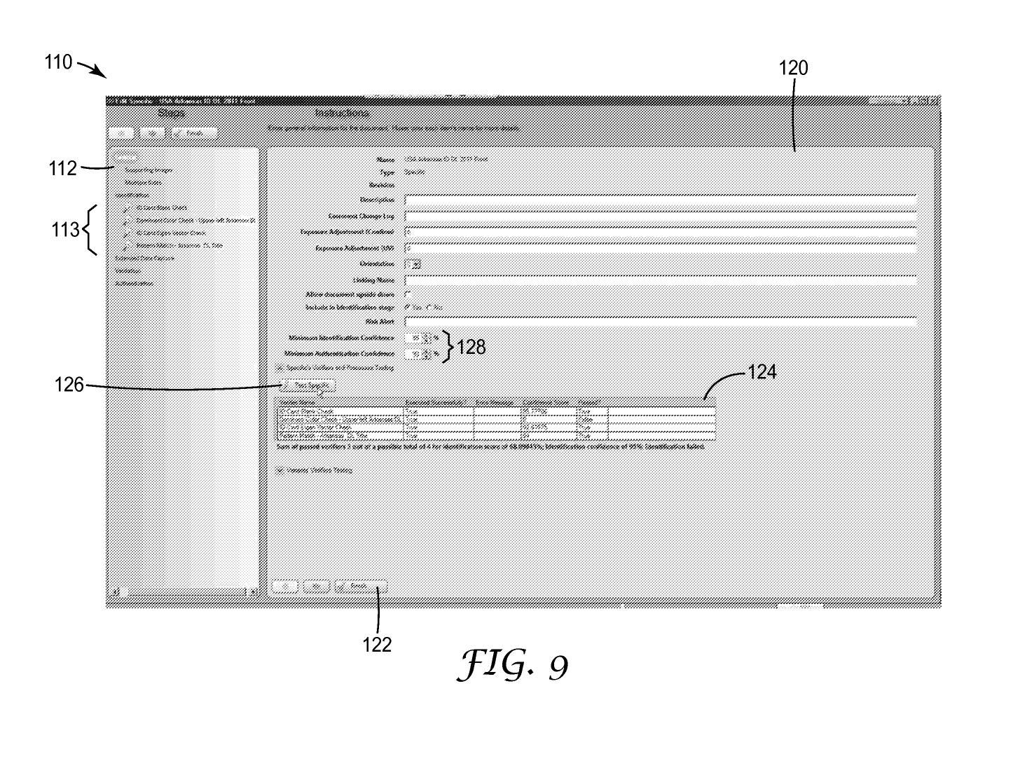

FIG. 9 illustrates window 110 having sub-window 120 with which the user interacts to perform a full test of the sequence of verifiers 113 for the defined identification process of the reference template for identifying the corresponding security document. Sub-widow 120 includes input buttons 122 that allow the user to incrementally step through each of the verifiers 113 of the identification process. During this process, template analysis component 23 sequentially invokes document processing engine 36 and directs the document processing engine to apply each verifier 113 to the entire sample reference document, such as security document 12. Sub-window 120 presents table 124 that displays the confidence score computed for each verifier. Test Specific button 126 allows the user to direct template analysis component 23 to test a particular one of the verifiers against sample reference document 14. For example, in FIG. 7, the dominant color check verifier returned a confidence score of zero when applied to the sample reference document. This may be an indication that the user has misconfigured the specific verifier in the reference template, and Test Specific button 126 allows the user to re-run the specific verifier without re-executing the entire sequence of verifiers 113 for document identification. Input fields 128 allow the user to specify a minimum identification confidence level and a minimum authentication confidence level for the entire set of verifiers 113.

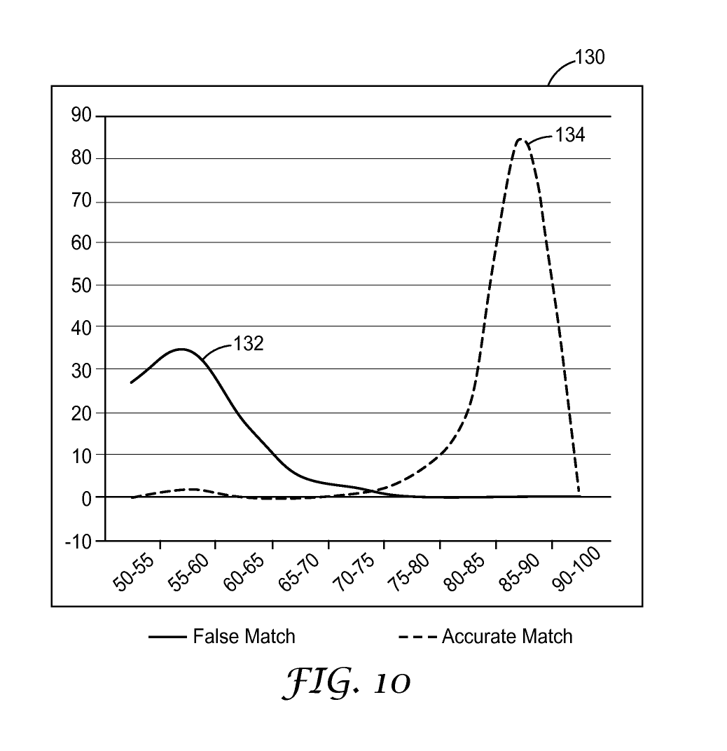

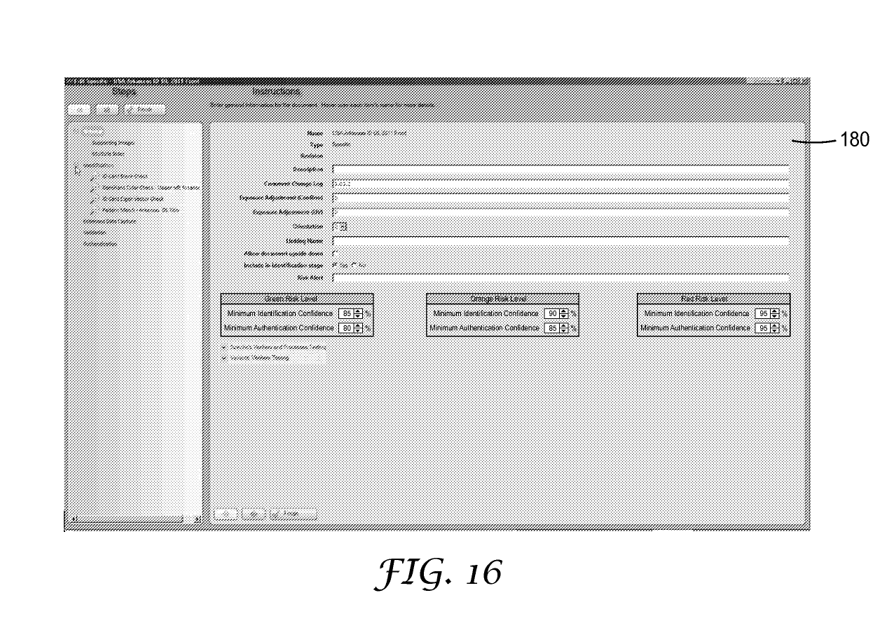

FIG. 10 illustrates an example graph 130 computed and displayed by template analysis component 23 to aid the user in setting confidence levels of FIG. 9. Graph 130 allows the user to perform a level of risk analysis when configuring the confidence levels for each reference template. More specifically, template analysis component 23 constructs graph 130 to show results of application of the reference template to a batch of sample security documents when the required confidence levels are set within various intervals over a range of confidence levels. Line 134 indicates resultant positive or accurate match rate while line 132 is false match rate for the given range of confidence levels. In this example, required confidence levels of below 65-70 result in significant false positives. Further, confidence levels of between 90 and 95 yield significant accurate match rates without yielding false positives. By computing this result data and constructing and displaying the data as a graph, template analysis component 23 allows the users to visualize and better understand the impact of changing the thresholds and, therefore, better select an appropriate balance between risk and computational complexity for the identification and authentication processes. In this way, template analysis component 23 assists organizations in understanding the different risk levels, and the effects therefrom, by batch testing of a set of sample security documents 12 to be invoked and automatically executed across multiple risk levels. The tool computes and displays statistical results across each level for the set of sample security documents, such as number of passed, false positive, false negatives and timing. The result shown in graph 130 can be generated across all the templates or for specific subsets or individual reference templates. As explained in further detail below with respect to FIG. 16, a user interface of the template analysis component 23 allows the user to define multilevel thresholds for each reference template. This is useful, for example, in that some identification and authentication processes are more time and resource intensive than others. Graph 130, as computed and displayed by template analysis component 23, may aid the user in setting different thresholds for different risk levels for a given reference template.

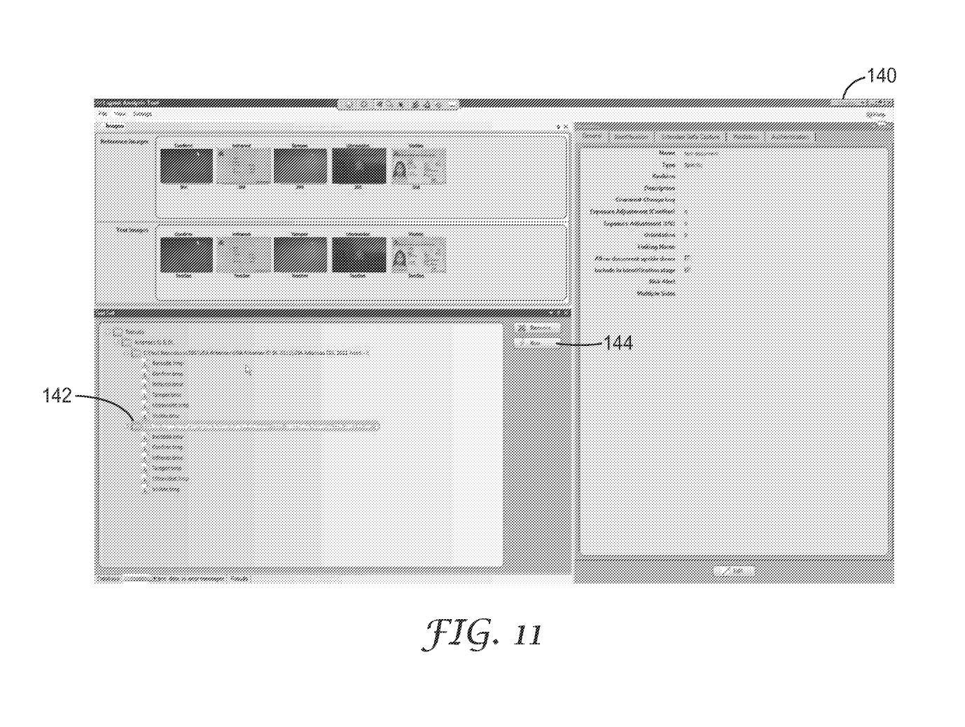

FIG. 11 illustrates an example window 140 with which the user interacts to place template analysis component 23 in a batch test mode. As shown, window 140 allows the user to select a set of test documents (test images) to be used for testing a reference template being created or modified. In this example, the user has selected a batch group 142 of sample documents to be applied against the reference template being created by selection of Run button 144.

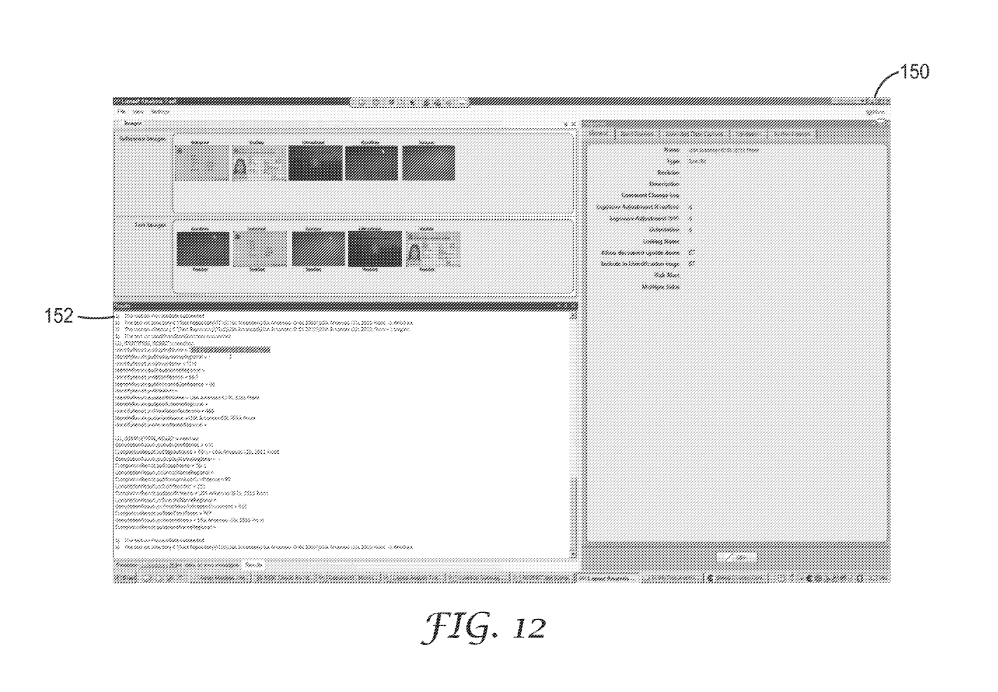

FIG. 12 illustrates window 150 that includes a sub-window 152 constructed by template analysis component 23 to show an execution history for application of the reference template being created against the previously selected batch group 142. Sub-window 152 shows the overall pass/fail results for both identification and authentication of each sample document using the reference template. In this example, sub-window 152 shows that document processing engine 36 correctly identified the sample documents as Arkansas drivers licenses and that each sample document was determined to be authentic.

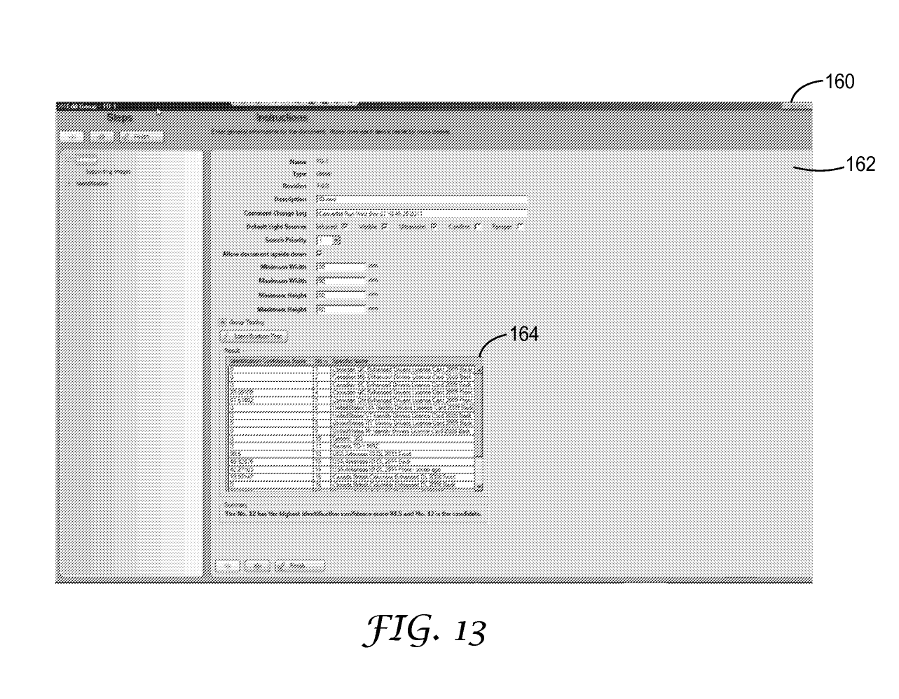

FIG. 13 illustrates window 160 that includes a sub-window 162 showing an execution history 164 for application of the current hierarchy of reference templates against a sample reference document. More specifically, template analysis component 23 invokes document processing engine 36 via API 37 and instructs the document processing engine to traverse the reference templates organized as document identification framework 34 as the hierarchy would be traversed in a real deployment environment. Execution history 164 shows the order of application of the reference templates, as defined by document identification framework 34. Moreover, the execution history shows a resultant confidence score for each reference template when applied to the sample security document. The scroll bar allows the user to scroll through and view the resultant confidence scores of each reference template applied to the sample reference document.

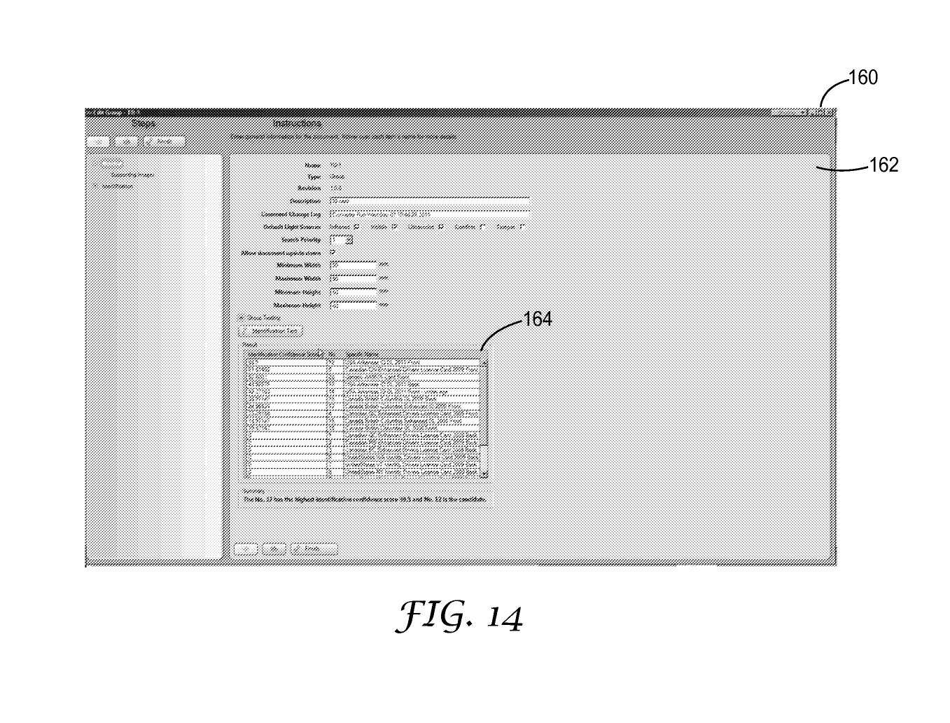

FIG. 14 illustrates sub-window 162 showing the execution history 164 in ranked form. That is, the applied reference templates are sorted and ranked by resultant confidence score. In this way, template analysis component 23 may assist the user in analyzing the placement of a newly created reference template within document identification framework 34 and, for example, determine the impact of the placement on the proper identification and authentication processes of other reference templates within the hierarchy. For example, the user may determine that an existing reference template located at a higher position within the hierarchy, i.e., closer to a root node of the hierarchy, incorrectly matches the sample reference document with a high confidence level and, therefore, may prevent the newly created reference template from being selected as the best match. This may be, for example, an indicator that the newly created reference template may need to be modified so as to be a best match for the particular type of security document of the sample reference document. As another example, the user may determine that the newly created reference template incorrectly matches a different type of security document with a confidence level that exceeds an existing reference template for that document type and, therefore, causes the hierarchy of references templates to no longer correctly identify security documents of that type. In this way, template analysis component 23 aids the user in determining the effectiveness of an overall solution of reference templates defined within document identification framework 34, which may be very useful given that identification and authentication processes tend to be very complex.

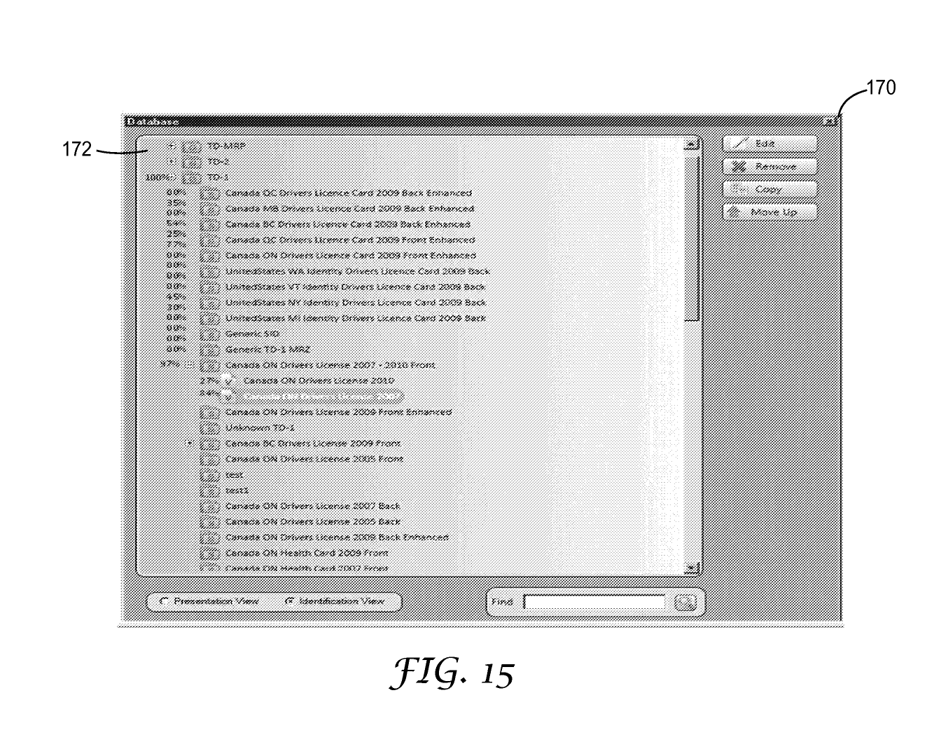

FIG. 15 illustrates a window 170 generated by template analysis component 23 that overlays the resultant confidence scores for each applied reference template with the graphical tree-like representation of the hierarchical arrangement of the reference templates within database 32. This may further aid the user in specifying each reference template and defining an overall solution provided by the hierarchy of reference templates.

FIG. 16 illustrates sub-window 180 that allows a user to specify multiple confidence levels for each of identification and authentication based on a risk tolerance. That is, the template analysis component allows the user to define a hierarchy of threat levels (e.g., Green, Orange and Red). In the example of FIG. 16, the user may then define different required confidence levels for the different Green, Orange and Red risk levels. In operation, document processing engine 36 utilizes the corresponding confidence levels specified for the currently set risk level. For example, a government, institution or organization may specify a risk level and, when applying a reference template, document processing engine 36 applies the confidence levels for that risk level (e.g., threat level) specified by that reference template.

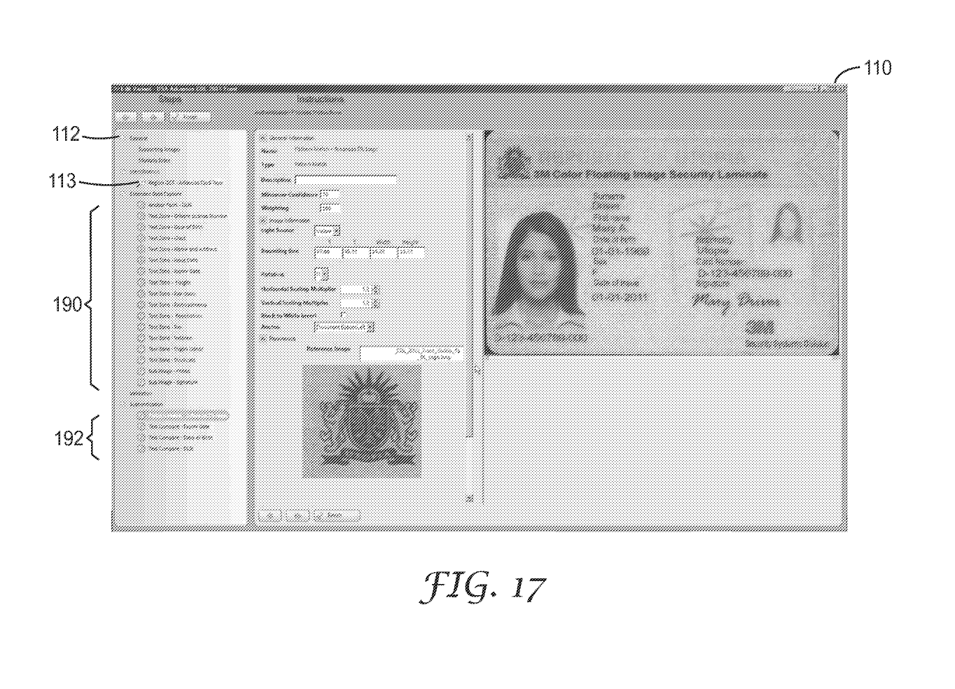

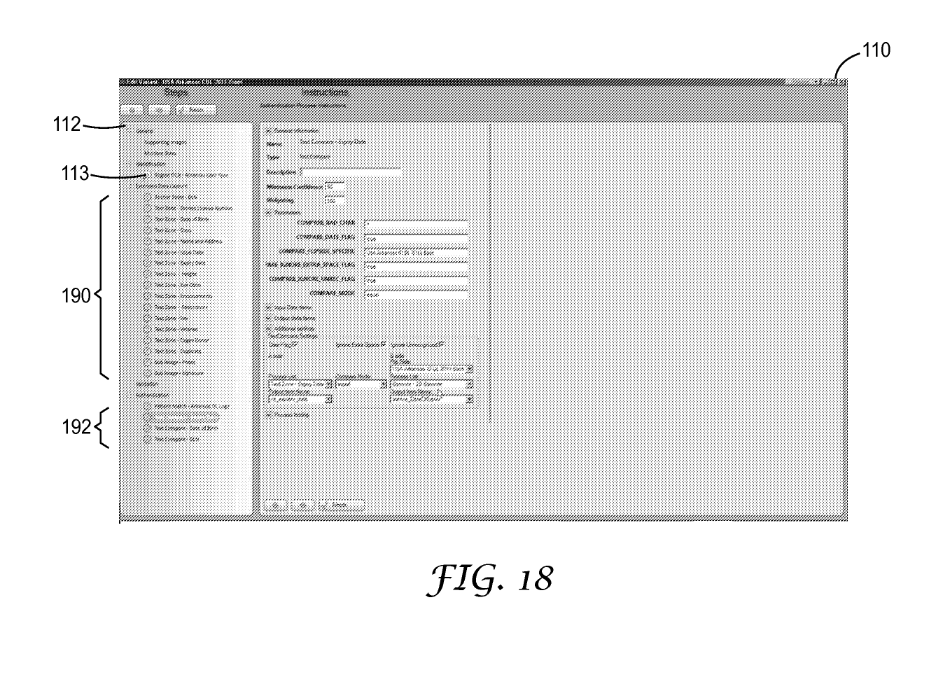

FIGS. 17-18 illustrate the final steps of defining a new reference template. For example, sub-window 112 shows user-defined processes 190 for capturing data from the security document once identified. In the example of FIGS. 17 and 18, processes 190 are defined for capturing a driver's license number, a date of birth, a vehicle class, a name and address and other information from the document. Further, FIGS. 17 and 18 show an example authentication process 192 defined for the document including the definition of four tests for authenticating a document once the document is identified as matching the requirements set forth in identifier 113 and the requisite data has been subsequently captured according to processes 190.

Various embodiments of the invention have been described. These and other embodiments are within the scope of the following claims.

1. A computer-implemented system comprising:
a host computer comprising a hardware-based processor and a software tool executing on the processor, wherein the software tool comprises:
a database storing a hierarchically arranged set of reference templates, each reference template defining a set of verifiers specifying instructions for identifying and authenticating a corresponding type of security document based on one or more attributes of the type of security document;
a document processing engine that controls a document reader to acquire data from an unknown type of security document and, in response to the data acquired by the document reader, applies the reference templates to the data to compute a score value for each reference template and identify the unknown security document as one of the types of security documents;
a template analysis component that presents an interface by which a user creates and edits the reference templates within the database,
wherein document processing engine and the template analysis component are integrated within the software tool and communicate by an application programming interface (API) within the software tool.

2. The system of claim 1, wherein the template analysis component invokes the document processing engine by the API while a user is editing one of the reference templates to test changes to the reference template with respect to the data acquired from the unknown type of security document without requiring that the user exit the template analysis component or restarting the document processing engine.

3. The system of claim 1,
wherein, in response to input from the user by a user interface, the template analysis component repeatedly invokes the document processing engine to apply the instructions of a reference template currently being edited to a plurality of security documents, and
wherein the template analysis component presents statistical metrics based on the application of the reference template currently being edited to the plurality of security documents.

4. The system of claim 1, wherein, in response to input from the user, the template analysis component operates in a parameter learning mode in which the template analysis component invokes the document processing engine to process the data from the unknown type of security document and present a set of initial settings for one or more of the verifiers for a reference template currently being edited within the template analysis component.

5. The system of claim 1, wherein, in response to input from the user, the template analysis component operates in a template learning mode in which the template analysis component invokes the document processing engine to process the data from the unknown type of security document and present a recommended position within the hierarchically arranged set of reference templates for a reference template currently being edited within the template analysis component.

6. The system of claim 1,
wherein the template analysis operator includes an editor by which the user specifies each of the verifiers for a reference template currently being edited,
wherein a user interface of the editor includes an input mechanism that directs the template analysis component to invoke the document processing engine to test any single one of the verifiers against the data from the unknown type of security document without invoking other ones of the verifiers defined for the reference template currently being edited.

7. The system of claim 1,
wherein the template analysis operator includes an editor by which the user specifies each of the verifiers for a reference template currently being edited,
wherein a user interface of the editor includes an input mechanism that directs the template analysis component to invoke the document processing engine to test the entire set of verifiers for the reference template currently being edited against the data from the unknown type of security document,
wherein, in response, the template analysis component receives and displays a confidence score computed for each of the verifiers by the document processing engine and presents a pass or fail indication for each of the verifiers.

8. The system of claim 1,
wherein the template analysis component includes an interface by which the user specifies a plurality of different threat levels, and
wherein the template analysis component includes an editor by which the user creates a new reference template and specifies a corresponding minimum confidence level for the new reference template for each of the different threat levels.

9. The system of claim 8, wherein, in response to input from the user, the template analysis component invokes the document processing engine to apply the new reference template to a plurality of security documents, and
wherein the template analysis component receives results from the document processing engine and constructs a graph showing an accuracy of the reference template in identifying the security documents over a range of confidence levels.

10. The system of claim 1,
wherein, in response to input from the user, the template analysis component operates in an execution trace mode for a new reference template currently being edited in which the template analysis component invokes the document processing engine to apply verifiers of the new reference template and present an execution history showing ordered results including a confidence score and pass or fail result computed by the document processing engine for each of the verifiers for the new reference template.

11. The system of claim 1,
wherein, in response to input from the user, the template analysis component operates in an execution trace mode for the hierarchy of reference templates in which the template analysis component invokes the document processing engine to apply the hierarchy of reference templates of the database to the data from the unknown type of security document and present an execution history showing ordered results for each of the reference templates applied including a confidence score computed for each of the reference templates by the document processing engine.

12. The system of claim 11, wherein the template analysis component constructs a user interface that graphically presents the hierarchy of reference templates in the database and overlays the confidence scores computed for each of the reference templates.

13. The system of claim 1, wherein the types of security documents includes passports and drivers licenses.

14. A method comprising:
receiving, with a template analysis component of a software tool executing on a computer, input from a user creating a new reference template within a hierarchy of reference templates stored in a database, wherein the input defines a verifier for the new reference template specifying instructions for identifying a corresponding type of security document based on one or more attributes of the type of security document;
invoking, with the template analysis component, a document processing engine integrated within the software tool to apply the verifier of the new reference template to data acquired from an unknown type of security document without requiring that the user exit the template analysis component or restarting the document processing engine; and
presenting results of application of the verifier through a user interface of the software tool.

15. The method of claim 14, further comprising:
in response to input from the user, operating the template analysis component in a learning mode in which the template analysis component invokes the document processing engine to process the data from the unknown type of security document and present a set of initial settings for one or more of the verifies for a reference template currently being edited within the template analysis component.

16. The method of claim 14, further comprising, in response to input from the user, the template analysis component operating in a learning mode in which the template analysis component invokes the document processing engine to process the data from the unknown type of security document and present a set of initial settings for one or more of the verifies for a reference template currently being edited within the template analysis component.

17. The method of claim 14, further comprising:
invoking, with the template analysis component, the document processing engine to test an entire set of verifiers for the new reference template against the data from the unknown type of security document, and
displaying, with the template analysis component, a confidence score and a pass or fail indication computed for each of the verifiers by the document processing engine.

18. The method of claim 14,
receiving input from the user specifying a plurality of different threat levels, and
receiving input from the user specifying a corresponding minimum confidence level for the new reference template for each of the different threat levels.

19. The method of claim 18, further comprising:
invoking the document processing engine with the template analysis component to apply the new reference template to a plurality of security documents, and
receiving results from the document processing engine and displaying a graph showing accuracy of the reference template in identifying the security documents over a range of confidence levels.

20. The method of claim 14, further comprising:
in response to input from the user, the template analysis component operating in an execution trace mode for the new reference template;
invoking the document processing engine to apply verifiers of the new reference template; and
presenting an execution history showing ordered results for including a confidence score and pass or fail result computed by the document processing engine for each of the verifiers for the new reference template.

21. The method of claim 14, further comprising,
in response to input from the user, the template analysis component operating in an execution trace mode for the hierarchy of reference templates;
invoking the document processing engine to apply the hierarchy of reference templates of the database to the data from the unknown type of security document; and
presenting an execution history showing ordered results for each of the reference templates applied including a confidence score computed for each of the reference templates by the document processing engine.

22. The method of claim 21, further comprising constructing, with the template analysis component, a user interface to graphically present the hierarchy of reference templates in the database and overlay the confidence scores computed for each of the reference templates.

23. A computer-readable medium comprising program code for causing a programmable processor to:
receive, with a template analysis component of a software tool executing on a computer, input from a user creating a new reference template within a hierarchy of reference templates stored in a database, wherein the input defines a verifier for the new reference template specifying instructions for identifying a corresponding type of security document based on one or more attributes of the type of security document;
invoke, with the template analysis component, a document processing engine integrated within the software tool to apply the verifier of the new reference template to data acquired from an unknown type of security document without requiring that the user exit the template analysis component or restarting the document processing engine; and
present results of application of the verifier through a user interface of the software tool.
